(19) United States
(12) Patent Application Publication
(10) Pub. No.: US 2021/0331447 A1
(43) Pub. Date: Oct. 28, 2021

(54) VISIBLE LIGHT SHIELDING STRUCTURE

(71) Applicant: NAN YA PLASTICS CORPORATION, Taipei (TW)

(72) Inventors: TE-CHAO LIAO, TAIPEI (TW); SEN-HUANG HSU, TAIPEI (TW); CHAO-QUAN WU, TAIPEI (TW)

(21) Appl. No.: 17/233,557

(22) Filed: Apr. 19, 2021

(30) Foreign Application Priority Data
Apr. 24, 2020 (TW) 109113724

(51) Int. Cl. B32B 15/08; B32B 15/04

(52) U.S. Cl. CPC B32B 15/08; B32B 2551/00; B32B 15/043

(57) ABSTRACT

A visible light shielding structure is provided. The visible light shielding structure includes a metal foil layer, two adhesive layers, and two synthesized paper layers. The metal foil layer has a first surface and a second surface opposite to the first surface. The two adhesive layers are disposed on the first surface and the second surface of the metal foil layer, respectively. The two synthesized paper layers are disposed on the two adhesive layers, respectively. Each of the two synthesized paper layers is a polypropylene based resin layer.

### CROSS-REFERENCE TO RELATED PATENT APPLICATION

This application claims the benefit of priority to Taiwan Patent Application No. 109113724, filed on Apr. 24, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a visible light shielding structure, and more particularly to a visible light shielding structure which can totally shield a visible light and reflect certain other types of light.

### BACKGROUND OF THE DISCLOSURE

Referring to FIG. 6, a conventional light shielding structure 9 includes a light shielding adhesive layer 90 and two resin layers 91 covering the light shielding adhesive layer 90. The light shielding structure 9 can prevent penetration of light by including the light shielding adhesive layer 90. Therefore, the light shielding structure 9 can be applied to printed matter, sunshades, advertising boards, and food packaging.

In the light shielding structure 9, the light shielding adhesive layer 90 disposed between the two resin layers 91 simultaneously performs an adhesive function to connect the two resin layers 91, and a light shielding function. Carbon black is added into the light shielding adhesive layer 90, so that the light shielding adhesive layer 90 has the light shielding function. The light shielding function of the light shielding adhesive layer 90 can be optimized by adjusting a concentration of the carbon black and a thickness of the light shielding adhesive layer 90.

When the concentration of the carbon black is increased, a light shielding effect of the light shielding adhesive layer 90 is enhanced; however, an adhesive effect of the light shielding adhesive layer 90 is weakened correspondingly. Accordingly, the amount of carbon black that can be added has an upper limit in order to uphold both the light shielding effect and the adhesive effect of the light shielding adhesive layer 90, which results in the light shielding effect of the light shielding adhesive layer 90 being restricted.

As a result of relevant measurements, the conventional light shielding structure 9 can only shield 99% of a visible light; that is, 1% of the visible light can still penetrate through the conventional light shielding structure 9. In addition, the conventional light shielding structure 9 cannot shield an ultraviolet light. When the conventional light shielding structure 9 is applied to a sunshade, the conventional light shielding structure 9 cannot effectively block sunlight from entering a house, which would affect daily routines of people who live inside the house. In addition, an indoor temperature of the house is significantly increased as a result of being exposed to direct sunlight, so that additional energy consumption (such as air conditioning) is needed to maintain a comfortable indoor temperature. Therefore, the conventional light shielding structure 9 still has room for improvement.

### SUMMARY OF THE DISCLOSURE

In response to the above-referenced technical inadequacies, the present disclosure provides a visible light shielding structure.

In one aspect, the present disclosure provides a visible light shielding structure. The visible light shielding structure includes a metal foil layer, two adhesive layers, and two synthesized paper layers. The metal foil layer has a first surface and a second surface opposite to the first surface. The two adhesive layers are disposed on the first surface and the second surface of the metal foil layer respectively. The two synthesized paper layers are disposed on the two adhesive layers respectively. Each of the two synthesized paper layers is a polypropylene based resin layer.

In certain embodiments, the visible light shielding structure has pliability.

In certain embodiments, a thickness of the visible light shielding structure ranges from 85 μm to 295 μm.

In certain embodiments, the metal foil layer is an aluminum foil, a tin foil, or a copper foil.

In certain embodiments, a thickness of the metal foil layer ranges from 5 μm to 15 μm.

In certain embodiments, a material of the adhesive layer is selected form the group consisting of polyurethane, acrylic, polyester, polyvinyl alcohol, and ethylene vinyl acetate copolymer.

In certain embodiments, a thickness of the adhesive layer ranges from 2 μm to 15 μm.

In certain embodiments, a thickness of the synthesized paper layer ranges from 38 μm to 125 μm.

In certain embodiments, the visible light shielding structure has a visible light shielding rate of 100% and a full-spectrum reflectivity of more than 89%.

In certain embodiments, a peeling strength of the visible light shielding structure is higher than 350 g/2.5 cm.

Therefore, by virtue of “the metal foil layer” and “the synthesized paper layer being a polypropylene based resin layer”, the visible light shielding structure can totally shield a visible light and reflect certain other types of light.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic cross-sectional view of a visible light shielding structure of the present disclosure;

FIG. 2 is a schematic cross-sectional view of a first step in a manufacturing process of the visible light shielding structure of the present disclosure;

FIG. 3 is a schematic cross-sectional view of a second step in the manufacturing process of the visible light shielding structure of the present disclosure;

FIG. 4 is a schematic cross-sectional view of a third step in the manufacturing process of the visible light shielding structure of the present disclosure;

FIG. 5 is a schematic cross-sectional view of a fourth step in the manufacturing process of the visible light shielding structure of the present disclosure; and

FIG. 6 is a schematic cross-sectional view of a conventional light shielding structure.

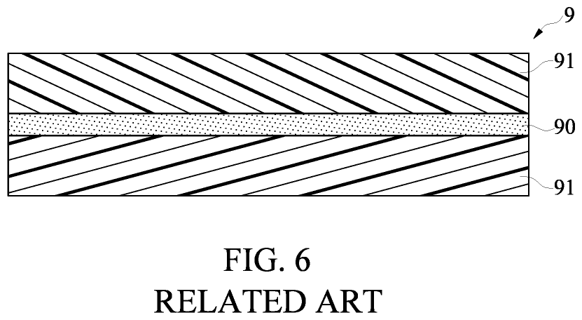

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a visible light shielding structure. The visible light shielding structure can totally shield a visible light (i.e., a visible light shielding rate of 100%) and has a good light reflection rate (a full-spectrum reflectivity of more than 89%). Specifically, the visible light shielding structure can block part of any infrared and ultraviolet light. In addition, the visible light shielding structure of the present disclosure has good uniformity of thickness, good printability, high durability, and good peeling strength, and can therefore be widely applied. For example, the visible light shielding structure can be used as a material for printed matter, advertising boards, packaging for goods or food, and sunshades.

A visible light shielding structure 1 of the present disclosure is a structure with at least five layers. The visible light shielding structure 1 can prevent penetration of a visible light and reflect certain other types of light (such as infrared and ultraviolet light). A total thickness of the visible light shielding structure 1 ranges from 50 μm to 500 μm. Preferably, the total thickness of the visible light shielding structure 1 ranges from 85 μm to 295 μm so as to be thin and light. Moreover, the visible light shielding structure 1 of the present disclosure has pliability, so that the visible light shielding structure 1 can be used in various fields.

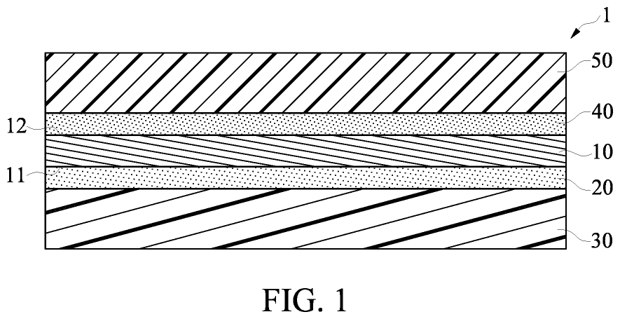

Referring to FIG. 1, the visible light shielding structure 1 of the present disclosure includes a metal foil layer 10, a first adhesive layer 20, a first synthesized paper layer 30, a second adhesive layer 40, and a second synthesized paper layer 50.

The metal foil layer 10 has a first surface 11 and a second surface 12 opposite to each other. The metal foil layer 10 is an opaque layer and is located innermost of the visible light shielding structure 1. In the present embodiment, a material of the metal foil layer 10 are metals with good malleability. For example, the metal foil layer 10 can be an aluminum foil, a copper foil, and a tin foil; preferably, the metal foil layer 10 is an aluminum foil. A thickness of the metal foil layer 10 ranges from 5 μm to 15 μm. Preferably, the thickness of the metal foil layer 10 ranges from 5 μm to 10 μm. Therefore, the metal foil layer 10 has pliability, and the visible light shielding structure 1 is thin and light.

The first adhesive layer 20 is disposed on the first surface 11 of the metal foil layer 10 (that is, a lower surface of the metal foil layer 10), so that the first synthesized paper layer 30 can be disposed upon the metal foil layer 10. In the present embodiment, a thickness of the first adhesive layer 20 ranges from 2 μm to 30 μm. Preferably, the thickness of the first adhesive layer 20 ranges from 2 μm to 15 μm. A material of the first adhesive layer 20 is selected from the group consisting of polyurethane (PU), acrylic, polyester, polyvinyl alcohol (PVA), and ethylene vinyl acetate copolymer (EVA), but is not limited thereto. Preferably, the material of the first adhesive layer 20 is polyurethane.

The first synthesized paper layer 30 disposed on the first adhesive layer 20 is an outer layer of the visible light shielding structure 1, so that the first synthesized paper layer 30 can protect the metal foil layer 10. In addition, a pattern can be printed onto the first synthesized paper layer 30. In the present embodiment, the first synthesized paper layer 30 is a polypropylene based resin layer. A thickness of the first synthesized paper layer 30 ranges from 30 μm to 200 μm. Preferably, the thickness of the first synthesized paper layer 30 ranges from 38 μm to 125 μm. The thickness of the first synthesized paper layer 30 can be adjusted according to different purposes.

The second adhesive layer 40 is disposed on the second surface 12 of the metal foil layer 10 (that is, an upper surface of the metal foil layer 10), so that the second adhesive layer 40 can be attached onto the metal foil layer 10. In the present embodiment, a thickness of the second adhesive layer 40 ranges from 2 μm to 30 μm. Preferably, the thickness of the second adhesive layer 40 ranges from 2 μm to 15 μm. A material of the second adhesive layer 40 is selected from the group consisting of polyurethane, acrylic, polyester, polyvinyl alcohol, and ethylene vinyl acetate copolymer, but is not limited thereto. Preferably, the material of the second adhesive layer 40 is polyurethane. Moreover, the material of the second adhesive layer 40 and the material of the first adhesive layer 20 can be the same or different.

The second synthesized paper layer 50 disposed on the second adhesive layer 40 is another outer layer of the visible light shielding structure 1, so that the second synthesized paper layer 50 can protect the metal foil layer 10. In addition, a pattern can be printed onto the second synthesized paper layer 50. In the present embodiment, the second synthesized paper layer 50 is another polypropylene based resin layer. A thickness of the second synthesized paper layer 50 ranges from 30 μm to 200 μm. Preferably, the thickness of the second synthesized paper layer 50 ranges from 38 μm to 125 μm. The thickness of the second synthesized paper layer 50 can be adjusted according to different purposes. Further, a material of the second synthesized paper layer 50 and a material of the first synthesized paper layer 30 can be the same or different.

Specifically, a material of the polypropylene based resin layer mentioned previously includes a polypropylene based resin, inorganic fillers, and at least one functional additive.

The polypropylene based resin at least includes polypropylene. The polypropylene based resin can further include polyethylene according to requirements. Generally, a texture of polypropylene is relatively hard, while a texture of polyethylene is relatively soft. Therefore, a hardness of the polypropylene based resin layer can be adjusted by adding polyethylene and adjusting a content ratio of polyethylene and polypropylene. Therefore, the visible light shielding structure 1 can be used in various fields.

When the polypropylene based resin includes polypropylene, the polypropylene based resin contains 63 wt % to 94.9 wt % of polypropylene. When the polypropylene based resin includes both polypropylene and polyethylene, the polypropylene based resin contains 63 wt % to 94.9 wt % of polypropylene and more than 0 wt % to 10 wt % of polyethylene.

The polypropylene mentioned previously can be propylene homopolymer (PP-H), propylene block copolymer (PP-B), polypropylene random copolymer (PP-R), or a combination thereof. The polyethylene mentioned previously can be ethylene homopolymer, ethylene copolymer, or a combination thereof.

In addition, polyethylene can be classified into high density polyethylene (HDPE), low density polyethylene (LDPE), linear low density polyethylene (LLDPE), or metallocene polyethylene (mPE) according to molecular structures and densities.

Based on the total weight of the polypropylene based resin layer being 100 wt %, the polypropylene based resin layer contains 5 wt % to 20 wt % of the inorganic fillers. The inorganic fillers are dispersed in the polypropylene based resin layer uniformly in the form of particles.

An addition of the inorganic fillers helps to enhance the structural strength of the synthesized paper layer and lower a material cost of the synthesized paper layer. The inorganic fillers can be selected from the group consisting of silicon dioxide, titanium oxide, zirconium oxide, aluminum oxide, aluminum hydroxide, calcium carbonate, magnesium carbonate, and barium sulfate. It is worth mentioning that, in consideration of a texture and a wet fastness of the synthesized paper layer, the inorganic fillers can be at least one selected from the group consisting of silicon dioxide, calcium carbonate, and barium sulfate in the present embodiment. An average diameter of the inorganic fillers ranges from 0.5 μm to 3 μm. However, these details are only possible implementations provided by the present embodiment, and should not be taken as limiting the scope of the present disclosure.

Based on the total weight of the polypropylene based resin layer being 100 wt %, the polypropylene based resin layer contains 0.1 wt % to 7 wt % of the functional additive. The functional additive is dispersed in the polypropylene based resin layer uniformly.

An addition of the functional additive can provide or improve some required properties of the polypropylene based resin layer. In the present embodiment, by taking into account that good weather resistance is required in the synthesized paper layer when being applied to outdoor advertising boards, the at least one functional additive can be an ultraviolet absorber (or an ultraviolet reflective agent), an antioxidant, a light stabilizer, or a combination thereof. In the present embodiment, based on the total weight of the polypropylene based resin layer being 100 wt %, the polypropylene based resin layer contains 0.1 wt % to 6 wt % of the ultraviolet absorber (or the ultraviolet reflective agent). Based on the total weight of the polypropylene based resin layer being 100 wt %, the polypropylene based resin layer contains more than 0 wt % to 1 wt % of the antioxidant.

The ultraviolet absorber can be a nickel quencher type ultraviolet absorber, an oxanilide type ultraviolet absorber, a benzotriazole type ultraviolet absorber, a benzoate type ultraviolet absorber, or a benzophenone type ultraviolet absorber. For example, the ultraviolet absorber can be ultraviolet absorbers with model numbers EUSORB® UV-P, EUSORB® UV-O, EUSORB® UV-9, EUSORB® UV-531, EUSORB® UV-327, EUSORB® UVPMB, EUSORB® UV-988, EUSORB® UV-1988, EUSORB® UV-3638, EUSORB® UV-LS144, or EUSORB® UV-310. The ultraviolet reflective agent can be talc, kaolin, zinc oxide, iron oxide, or titanium dioxide. The antioxidant can be a hindered phenol type antioxidant, an amine type antioxidant, a triazine type antioxidant, an organophosphate type antioxidant, or a thioester type antioxidant. The light stabilizer can be AM101 or 744 light stabilizers. However, these details are only possible implementations provided by the present embodiment, and should not be taken as limiting the scope of the present disclosure.

Referring to FIGS. 1 to 5, the visible light shielding structure 1 of the present disclosure is manufactured by a roll to roll process, which is suitable for large-scale and continuous production. Accordingly, the production efficiency of the visible light shielding structure 1 can be enhanced, and the material cost of the visible light shielding structure 1 can be reduced.

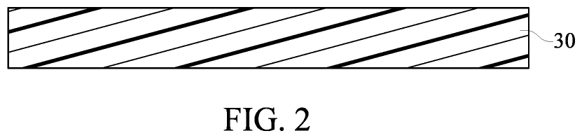

A method for manufacturing the visible light shielding structure 1 includes the following steps. A polypropylene based resin composition is prepared, and then is granulated to form polypropylene based resin masterbatches (step S100). The polypropylene based resin masterbatches, the inorganic fillers, and the at least one functional additive are mixed and melted, are extruded by an extruder, and then undergo vertically and horizontally extension processes, so that the first synthesized paper layer 30 as shown in FIG. 2 can be obtained (step S110). In addition, a printing layer (not shown in the drawing) can be formed onto the first synthesized paper layer 30 by an embossing step or a printing step.

In the step S100, a solid content of the polypropylene based resin composition ranges from 99.8 wt % to 99.9 wt %.

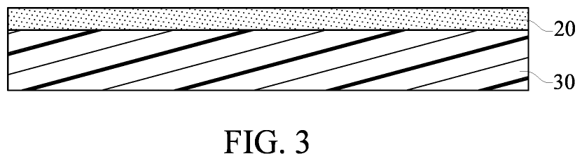

The method for manufacturing the visible light shielding structure 1 includes the following steps. An adhesive paste is prepared (step S120). The adhesive paste is coated onto the first synthesized paper layer 30. After being solidified, the adhesive paste is turned into the first adhesive layer 20 as shown in FIG. 3 (step S130).

In the step S120, the adhesive paste (including polyurethane pastes 1 to 3, acrylic paste, polyester paste, polyvinyl alcohol paste, and ethylene vinyl acetate copolymer paste) is prepared according to components listed in Table 1. Based on the total weight of the adhesive paste being 100 wt %, the adhesive paste at least includes a main resin of 31.9 wt % to 57.9 wt %, a hardener of 4 wt % to 5.2 wt %, and a solvent of 25.3 wt % to 41.2 wt %. The main resin changes according to different types of the adhesive paste.

TABLE 1

| | | | | Solid |
|---|---|---|---|---|
| | Main resin | Hardener | Solvent | content |
| Polyurethane paste 1 | 43.5 wt % | 4.3 wt % | 30.5 wt % | 38.9 wt % |
| Polyurethane paste 2 | 50.5 wt % | 4.0 wt % | 25.3 wt % | 41.2 wt % |
| Polyurethane paste 3 | 43.1 wt % | 5.2 wt % | 38.8 wt % | 33.6 wt % |
| Acrylic paste | 43.5 wt % | 4.3 wt % | 30.5 wt % | 38.9 wt % |
| Polyester paste | 43.5 wt % | 4.3 wt % | 30.5 wt % | 38.9 wt % |
| Polyvinyl alcohol paste | 50.5 wt % | 4.0 wt % | 25.3 wt % | 41.2 wt % |
| Ethylene vinyl acetate | 43.1 wt % | 5.2 wt % | 38.8 wt % | 33.6 wt % |
| copolymer paste | | | | |

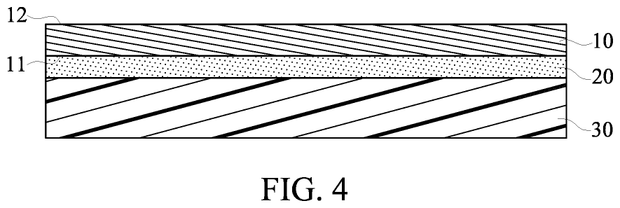

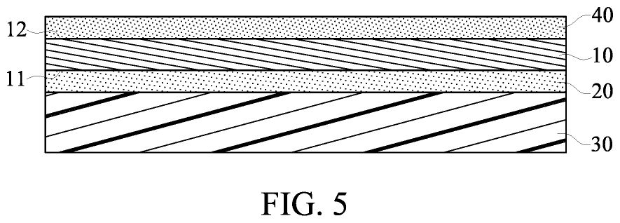

The method for manufacturing the visible light shielding structure 1 includes the following steps. The metal foil layer 10 is disposed onto the first adhesive layer 20 as shown in FIG. 4 (step S140). Another adhesive paste is prepared according to the components listed in Table 1 (step S150), and is coated onto the metal foil layer 10. After being solidified, the another adhesive paste is turned into the second adhesive layer 40 as shown in FIG. 5 (step S160). The adhesive paste in step S150 and the adhesive paste in step 120 can be the same or different. Another polypropylene based resin composition is prepared, and then is granulated to form polypropylene based resin masterbatches (step S170). The polypropylene based resin masterbatches, the inorganic fillers, and the at least one functional additive are mixed and melted, are extruded by an extruder, and undergo vertically and horizontally extension processes, so that the second synthesized paper layer 50 can be obtained (step S180). In addition, a printing layer (not shown in the drawing) can be formed onto the second synthesized paper layer 50 by an embossing step or a printing step.

In step S170, a solid content of the polypropylene based resin composition ranges from 99.8 wt % to 99.9 wt %. It is worth mentioning that the polypropylene based resin composition in step S170 and the polypropylene based resin composition in step S100 can be the same or different.

To prove the effects of the visible light shielding structure of the present disclosure, Examples 1 to 3 of the visible light shielding structures are prepared by the method mentioned previously. Comparative Examples 1 and 2 of the visible light shielding structures are prepared by a similar method. The difference between Comparative Examples 1 and 2 and Examples 1 to 3 is that: materials of the first synthesized paper layer 30 and the second synthesized paper layer 50 in Comparative Examples 1 and 2 are polyethylene terephthalate (PET), not the polypropylene (PP).

Thicknesses and materials of the layers in the visible light shielding structure of Examples 1 to 3 and Comparative Examples 1 and 2 are listed in Table 2. Visible light transmittances, visible light shielding rates, full-spectrum reflectivity, uniformity of thickness, printability, weather resistances, and peeling strengths of the visible light shielding structures of Examples 1 to 3 and Comparative Examples 1 and 2 are measured, evaluated, and listed in Table 2.

The visible light transmittance of the visible light shielding structure is measured by a light transmittance analyzer (provided by NIPPON DENSHOKU INDUSTRIES, model: NDH7000). The visible light transmittance of the visible light shielding structure is calculated by means of diffused light and penetrating light.

The visible light shielding rate of the visible light shielding structure is calculated by a formula of [100%−(the visible light transmittance)].

The full-spectrum reflectivity of the visible light shielding structure is measured by a UV/visible/NIR spectrophotometer provided by PerkinElmer, Inc.

A central part of the visible light shielding structure is cut into a sample with a length (MD) of 30 cm, a width (TD) of 30 cm, and a thickness of 50 mm. Thicknesses of the sample is measured by a continuous thickness meter (provided by FUJI CORP., model: S-2268) to obtain an average thickness in a width direction and an average thickness in a length direction. The uniformity of thicknesses of the visible light shielding structure is evaluated by calculating a difference between the maximum value of thickness and the minimum value of thickness. When the difference is lower than 5 μm, the uniformity of thicknesses of the visible light shielding structure is marked as “∘”. When the difference is between 5 μm and 10 μm, the uniformity of thicknesses of the visible light shielding structure is marked as “Δ”. When the difference is higher than 10 μm, the uniformity of thicknesses of the visible light shielding structure is marked as “x”.

The printability of the visible light shielding structure is evaluated by being printed by a printing machine. The symbol of “∘” represents that the visible light shielding structure has a good printability. A symbol of “Δ” represents that the visible light shielding structure has a medium printability. A symbol of “x” represents that the visible light shielding structure has a poor printability.

A central part of the visible light shielding structure is cut into a sample with a length of 15 cm and a width of 7.5 cm. The sample is exposed to a UV light testing machine (provided by ATLAS TECHNOLOGY CORP., model: ATLAS UV) for 600 days. The weather resistance of the visible light shielding structure is evaluated by comparing a part exposed to UV light and a part not exposed to UV light of the visible light shielding structure. A symbol of “∘” represents that appearances and textures of the part exposed to UV light and the part not exposed to UV light are similar. A symbol of “Δ” represents that the appearances and the textures of the part exposed to UV light and the part not exposed to UV light are slightly different. A symbol of “x” represents that the appearances and the textures of the part exposed to UV light and the part not exposed to UV light are significantly different.

The peeling strength of the visible light shielding structure is measured by a universal testing machine (provided by COMETECH TESTING MACHINES CO., model: QC508PA). Parameters set on the universal testing machine include a peeling velocity of 300 mm/min, a peeling direction vertical to the ground, and a peeling angle of 180°.

TABLE 2

| | | | | | Comparative | |
|---|---|---|---|---|---|---|
| | | Example | | | Example | |
| | | 1 | 2 | 3 | 1 | 2 |
| First synthesized | Material | PP | PP | PP | PET | PET |
| paper layer | Thickness | 60 μm | 75 μm | 95 μm | 125μm | 125 μm |
| First adhesive | Material | PU | PU | PU | Acrylic | Polyester |
| layer | Thickness | 5 μm | 8 μm | 3 μm | 10 μm | 10 μm |
| Metal foil layer | Thickness | 9 μm | 6 μm | 12 μm | 10 μm | 10 μm |
| Second adhesive | Material | PU | PU | PU | Acrylic | Polyester |
| layer | Thickness | 5 μm | 8 μm | 3 μm | 10 μm | 10 μm |
| Second synthesized | Material | PP | PP | PP | PET | PET |
| paper layer | Thickness | 60 μm | 75 μm | 95 μm | 125 μm | 125 μm |

| | | | | | |
|---|---|---|---|---|---|
| Visible light transmittance | 0% | 0% | 0% | 0% | 0.09% |
| Visible light shielding rate | 100% | 100% | 100% | 100% | 99.91% |
| Full-spectrum reflectivity | 91% | 90% | 89% | 86% | 85% |
| Uniformity of thickness | ◯ | ◯ | ◯ | ◯ | ◯ |
| Printability | ◯ | ◯ | ◯ | ◯ | ◯ |
| Weather resistance | ◯ | ◯ | ◯ | Δ | Δ |
| Peeling strength (g/2.5 cm) | 352 | 364 | 368 | 428 | 265 |

According to results in Table 2, the visible light shielding structure 1 of the present disclosure can totally prevent penetration of a visible light and has a full-spectrum reflectivity of more than 89%. Moreover, the visible light shielding structure 1 of the present disclosure has good uniformity of thickness, printability, weather resistance, and peeling strength.

In conclusion, by virtue of “the metal foil layer 10” and “the synthesized paper layers 30, 50 being a polypropylene based resin layer”, the visible light shielding structure 1 can totally shield a visible light and reflect certain other types of light (e.g., infrared and ultraviolet light).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A visible light shielding structure, comprising:
a metal foil layer having a first surface and a second surface opposite to the first surface;
two adhesive layers disposed on the first surface and the second surface of the metal foil layer, respectively; and
two synthesized paper layers disposed on the two adhesive layers, respectively, each of the two synthesized paper layers being a polypropylene based resin layer.

2. The visible light shielding structure according to claim 1, wherein the visible light shielding structure has pliability.

3. The visible light shielding structure according to claim 1, wherein a thickness of the visible light shielding structure ranges from 85 μm to 295 μm.

4. The visible light shielding structure according to claim 1, wherein the metal foil layer is an aluminum foil, a tin foil, or a copper foil.

5. The visible light shielding structure according to claim 1, wherein a thickness of the metal foil layer ranges from 5 μm to 15 μm.

6. The visible light shielding structure according to claim 1, wherein a material of the adhesive layer is selected from the group consisting of polyurethane, acrylic, polyester, polyvinyl alcohol, and ethylene vinyl acetate copolymer.

7. The visible light shielding structure according to claim 1, wherein a thickness of the adhesive layer ranges from 2 μm to 15 μm.

8. The visible light shielding structure according to claim 1, wherein a thickness of the synthesized paper layer ranges from 38 μm to 125 μm.

9. The visible light shielding structure according to claim 1, wherein the visible light shielding structure has a visible light shielding rate of 100% and a full-spectrum reflectivity of more than 89%.

10. The visible light shielding structure according to claim 1, wherein a peeling strength of the visible light shielding structure is higher than 350 g/2.5 cm.
